(19) United States
(12) Patent Application Publication
(10) Pub. No.: US 2024/0385000 A1
(43) Pub. Date: Nov. 21, 2024

(54) SYSTEM FOR MONITORING VEHICLE CARBON FOOTPRINT AND GENERATING PLAN OF CARBON EMISSION REDUCTION AND VEHICLE MANAGEMENT SYSTEM INCLUDING THE SAME

(71) Applicant: Pin-Huan CHOU, Taoyuan City (TW)

(72) Inventors: Pin-Huan CHOU, Taoyuan City (TW); Kai-Cheng CHUANG, Nantou County (TW)

(73) Assignee: Pin-Huan CHOU, Taoyuan City (TW)

(21) Appl. No.: 18/664,154

(22) Filed: May 14, 2024

Related U.S. Application Data
(60) Provisional application No. 63/502,119, filed on May 15, 2023.

(51) Int. Cl. G01C 21/34; G06Q 10/04; G06Q 10/0631; G06Q 50/40

(52) U.S. Cl. CPC G01C 21/3469; G01C 21/3492; G06Q 10/04; G06Q 10/06311; G06Q 50/40

(57) ABSTRACT

A system for monitoring vehicle carbon footprint and generating plan of carbon emission reduction is disclosed. The system can be integrated in a vehicle management system, and comprises a server, a plurality of vehicle-end electronic devices, a plurality of user-end electronic devices, and a plurality of sensor assemblies. The sensor assembly is adopted for collecting a driving data of a transportation vehicle under execution task, and the server is configured to perform multiple functions including: conducting, based on a demand of vehicle utilization sent by the user-end electronic device, generation of transportation routes, calculation of an estimation carbon emission, dispatch of a transportation task; calculating, after the transportation vehicle travels along the transportation route so as to finish the transportation task, a real carbon emission based on the driving data; and calculating a bonus based on a difference between the real carbon emission and the estimation carbon emission.

### BACKGROUND OF THE INVENTION

### 1. Field of the Invention

The present invention relates to the technology field of vehicle management system, and more particularly to a system for monitoring vehicle carbon footprint and generating plan of carbon emission reduction which can be integrated in the vehicle management system.

### 2. Description of the Prior Art

It is well known that vehicle management system has been applied in goods transportation system and people transportation system. The vehicle management system acquires, by using a locating technique of GPS or LBS, a vehicle location of each of a plurality of transportation vehicles the vehicle management system can dispatch and a user location of each of users they use a vehicle management APP by operating their own smartphones, thereby generating a transportation plan.

However, the conventional vehicle management system is found to exhibit shortcomings in practical application. First of all, the vehicle management system often dispatches the transportation vehicle that spaces the shortest distance apart from the user to conduct the transport task, but does not simultaneously determine whether a return trip of the transportation vehicle lead to lead to an excessive fuel consumption. Second, the vehicle management system often dispatches the transportation vehicle that spaces the shortest distance apart from the user to conduct the transport task, but does not simultaneously consider that the fuel consumption is directly proportional to the vehicle volume of the transportation vehicle.

Therefore, it is realized that there are still rooms for improvement in the conventional vehicle management system. In view of this fact, inventors of the present application have made great efforts to make inventive research and eventually provided a system for monitoring vehicle carbon footprint which can be integrated in the vehicle management system.

### SUMMARY OF THE INVENTION

The primary objective of the present invention is to disclose a system for monitoring vehicle carbon footprint and generating plan of carbon emission reduction, and this system can be integrated in a vehicle management system. When a user employs the vehicle management system by operating a user-end electronic device (e.g., smartphone) thereof, the system of the present invention is enabled to generate a plurality of advisory transportation routes based on a demand of vehicle utilization that is sent by the user-end electronic device, assign a specific transportation vehicle a transportation task, and calculate an estimation carbon emission. Particularly, the plurality of advisory transportation routes comprises transportation route with shortest-distance, transportation route with lowest amount of time spending, transportation route with lowest price, and transportation route with lowest carbon emission, and the user is allowed to select one of the foregoing transportation routes. In addition, after the transportation vehicle completes the transportation task by travelling along the user-denoted transportation route, the system of the present invention subsequently calculates a real carbon emission based on a driving data of the transportation vehicle, and then calculates a bonus based on a difference between the real carbon emission and the estimation carbon emission, thereby rewarding the bonus to the user and/or the driver of the transportation vehicle.

Furthermore, an analysis is conducted by the system of the present invention after one transportation task is finished, such that a plurality of factors leading the real carbon emission to be lower than the estimation carbon emission are determined. The plurality of factors may include, for example, real traveling route of the transportation vehicle being different from the user-denoted transportation route, vehicle speed, engine speed, grade of gasoline, wind speed, gradient of road, and humidity. As a result, the system of the present invention is able to, by utilizing the factors, generate a new transportation route with more reduced carbon emission compared to the transportation route with the lowest carbon emission generated before.

For achieving the primary objective mentioned above, the present invention provides an embodiment of the system for monitoring vehicle carbon footprint and generating plan of carbon emission reduction, which comprises:
at least one server;
a plurality of vehicle-end electronic devices in communication with the at least one server, wherein each of plurality of vehicle-end electronic devices is correspondingly disposed in each of a plurality of vehicles with contract for undertaking transportation tasks;
a plurality of user-end electronic devices in communication with the at least one server; and
a plurality of sensor assemblies, wherein each of plurality of sensor assemblies is correspondingly disposed in each of the plurality of vehicles, and the sensor assembly communicating the at least one server directly or through the vehicle-end electronic device;
wherein the server comprises at least one processor and at least one storage module storing an application program, and the processor executing the application program so as to be configured to:
   generate, after receiving a demand of vehicle utilization sent by one of the plurality of the user-end electronic devices, an estimation value of carbon emission and a transportation plan comprising a plurality of advisory transportation routes based on the demand of vehicle utilization, at least one vehicle parameter and at least one road condition parameter; wherein the demand of vehicle utilization includes an information consisting of model of vehicle, starting location and destination location;
   transmit a transportation task assigning notification to one of the plurality of vehicle-end electronic devices that stays in the vehicle meeting a requirement of the demand of vehicle utilization;
   dispatch, after receiving a response information from the vehicle-end electronic device, the vehicle as a transportation vehicle;
   collect, through the sensor assembly, a driving data of the transportation vehicle while the transportation vehicle travels along the advisory transportation route;
   calculate, after the transportation vehicle completes the transportation task, a real value of carbon emission of the transportation vehicle; and
   calculate, in case of the real value of carbon emission being lower than the estimation value of carbon emission, a bonus of carbon emission reducing based on a difference between the real value of carbon emission and the estimation value of carbon emission.

In one practicable embodiment, the processor executing the application program is further configured to:
allot, after exchanging the bonus of carbon emission reducing to a reward, the reward to a user of the user-end electronic device and/or a driver of the vehicle-end electronic device;
wherein the reward comprises at least one selected from a group consisting of reward points, gift voucher, discount coupon, cash voucher, and currency.

In one embodiment, the transportation vehicle is selected from a group consisting of bicycle, electric bicycle (E-bike), motorcycle, scooter, electric motorcycle, electric scooter, gasoline-powered vehicle, and electric vehicle.

In one embodiment, the vehicle parameter is selected from a group consisting of brand of vehicle, model of vehicle, vehicle weight, and vehicle emission standard.

In one embodiment, the road condition parameter is selected from a group consisting of type of road, gradient of road, speed limit of road, current traffic flow of road, environment temperature, environment humidity, and environment wind speed.

In one embodiment, the transportation plan further comprises at least one driving advice selected from a group consisting of driving speed, engine speed and tire pressure.

In one embodiment, the driving data comprises at least one selected from a group consisting of real transportation route, trip corresponding to the foregoing real transportation route, and fuel consumption corresponding to the foregoing real transportation route.

In one embodiment, the sensor assembly is selected from a group consisting of OBD (on-board diagnostics) device, ODB-II (second generation on-board diagnostics) device, OTA (over-the-air technology)) device, and TMS (transportation management system) device.

In one embodiment, the plurality of advisory transportation routes comprises transportation route with shortest-distance, transportation route with lowest amount of time spending, transportation route with lowest price, and transportation route with lowest carbon emission.

In one embodiment, the vehicle-end electronic device comprises a first processor and a first storage module storing a first application program, the first processor executes the first application program so as to be configured to:
control the vehicle-end electronic device to communicate with the server;
control a first display of the vehicle-end electronic device to show a driver operation interface; and
receive a driver operation through the driver operation interface;
wherein the driver operation is selected from a group consisting of vehicle owner registering, management of vehicle owner information, vehicle information management, vehicle owner log in, acceptation or rejection of transportation task, giving of user score, giving of system score, bank account setting, and enquiry for specific remuneration defrayment corresponding the transportation task.

In one embodiment, the user-end electronic device comprises a second processor and a second storage module storing a second application program, the second processor executes the second application program so as to be configured to:
control the user-end electronic device to communicate with the server;
control a second display of the user-end electronic device to show a user operation interface; and
receive a user operation through the user operation interface;
wherein the user operation is selected from a group consisting of user registering, user information management, user log in, editing of the demand of vehicle utilization, sending out of the demand of vehicle utilization, giving of vehicle owner score, giving of system score, order querying, order revising, order canceling, bank account setting, and enquiry for specific expense payment corresponding the transportation task.

In one practicable embodiment, the system according to the present invention further comprises:
a plurality of administrator-end electronic devices in communication to the at least one server;
wherein the administrator-end electronic device comprises at least one third processor and at least one third storage module storing a third application program, and the third processor executing the third application program so as to be configured to:
   control the administrator-end electronic device to communicate with the server;
   control a third display of the administrator-end electronic device to show an administrator operation interface; and
   receive an administrator operation through the administrator operation interface;
wherein the administrator operation is selected from a group consisting of bonus management, user data management, vehicle owner data management, vehicle data management, transportation task management, order management, user score management, and vehicle owner score management.

In one embodiment, the storage module, the first storage module, the second storage module, and the third storage module are all selected from a group consisting of hard drive (HD), external hard drive, solid-state drive (SSD), and flash drive.

In one embodiment, the storage module includes a user database, a vehicle owner database, a vehicle database, a transport task database.

In one embodiment, the application program comprises a plurality of subprograms, and the plurality of subprograms comprise:
a first subprogram, including instructions for configuring the processor to receive the driver operation through a communication interface of the server, and then manage the driver operation;
a second subprogram, including instructions for configuring the processor to receive the user operation through the communication interface, and then manage the user operation;
a third subprogram, including instructions for configuring the processor to receive the administrator operation through the communication interface, and then manage the administrator operation;
a fourth subprogram, including instructions for configuring the processor to:
   generate an original transportation route based on the demand of vehicle utilization; and
   generate, after applying N times of route adjusting process to the original transportation route under taking the at least one vehicle parameter and the at least one road condition parameter as a plurality of adjusting factors, the plurality of advisory transportation routes; wherein N is a positive integer;
a fifth subprogram, including instructions for configuring the processor to:
   receive the demand of vehicle utilization through the communication interface;
   transmit, through the communication interface, the transportation task assigning notification to one of the plurality of vehicle-end electronic devices;
   record a device information of the vehicle-end electronic device while receiving the response information from the vehicle-end electronic device, and simultaneously record a vehicle information of the vehicle carrying the vehicle-end electronic device;
   record the driving data and a real transportation route of the transportation vehicle and the transportation task in the transport task database; and
   calculate, after the transportation vehicle completes the transportation task, the real value of carbon emission of the transportation vehicle;
a sixth subprogram, including instructions for configuring the processor to:
   communicate with the vehicle-end electronic device through the communication interface, so as to receive a user score data or a first system score data; and
   communicate with the user-end electronic device through the communication interface so as to receive a vehicle owner score data or a second system score data;
a seventh subprogram, including instructions for configuring the processor to communicate with the user-end electronic device so as to receive and manage a user operation of order querying, a user operation of order revising, or a user operation of order canceling;
an eighth subprogram, including instructions for configuring the processor to:
   communicate with the vehicle-end electronic device through the communication interface, so as to send a remuneration defrayment notification to the vehicle-end electronic device after the vehicle completes the transportation task;
   receive and manage a driver operation of enquiry for specific remuneration defrayment corresponding the transportation task;
   communicate with the user-end electronic device through the communication interface, so as to send an expense payment notification to the user-end electronic device after the vehicle completes the transportation task; and
   receive and manage a user operation of enquiry for specific expense payment corresponding the transportation task; and
a ninth subprogram, including instructions for configuring the processor to:
   calculate the bonus based on the difference between the real value of carbon emission and the estimation value of carbon emission;
   exchange the bonus of carbon emission reducing to the reward; and
   allot the reward to the user of the user-end electronic device and/or the driver of the vehicle-end electronic device.

In one practicable embodiment, the plurality of subprograms further comprise:
a tenth subprogram, including instructions for configuring the processor to:
   input the real value of carbon emission, the estimation value of carbon emission, the real transportation route, the driving data, the at least one vehicle parameter, and the at least one road condition parameter into a pre-trained factor analysis model, such that at least one factor leading the real value of carbon emission to be lower than the estimation value of carbon emission is found out by the factor analysis model.

In one embodiment, the possessor modulates a first weight corresponding to the vehicle parameter and a second weight corresponding to the road condition parameter while generating the transportation plan.

In addition, the present invention simultaneously an embodiment of a vehicle management system, which is characterized by comprising one system for monitoring vehicle carbon footprint and generating plan of carbon emission reduction according to the present invention.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 is an architecture diagram of a system for monitoring vehicle carbon footprint and generating plan of carbon emission reduction according to the present invention;

FIG. 2 is a block diagram of the system for monitoring vehicle carbon footprint and generating plan of carbon emission reduction according to the present invention;

FIG. 3 is a schematic front view of a vehicle-end electronic device;

FIG. 4 is a schematic front view of a use-end electronic device;

FIG. 5 is a block diagram of a storage module as shown in FIG. 2; and

FIG. 6 is a schematic diagram of an administrator-end electronic device as shown in FIG. 1.

### DETAILED DESCRIPTION OF THE PREFERRED EMBODIMENTS

To more clearly describe a system for monitoring vehicle carbon footprint and generating plan of carbon emission reduction according to the present invention, embodiments of the present invention will be described in detail with reference to the attached drawings hereinafter.

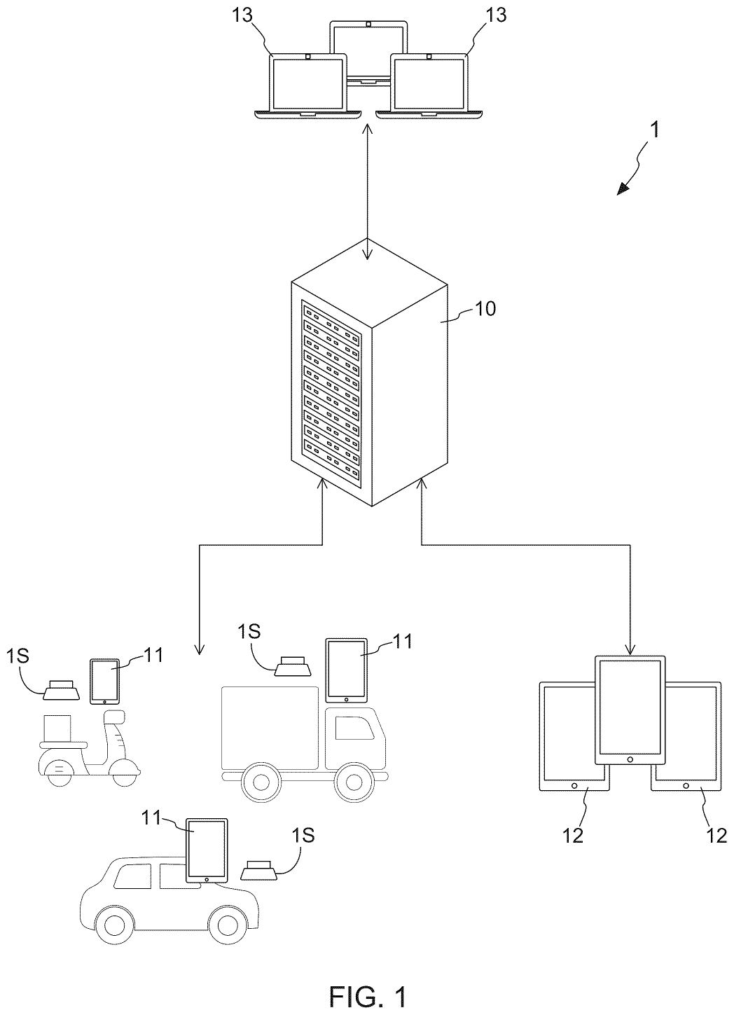

The present invention discloses a system for monitoring vehicle carbon footprint and generating plan of carbon emission reduction, which can be integrated in a vehicle management system, and the vehicle management system is applied in a goods transportation system or a people transportation system. FIG. 1 illustrates an architecture diagram of the system 1 for monitoring vehicle carbon footprint and generating plan of carbon emission reduction according to the present invention. As FIG. 1 shows, the system 1 comprises at least one server 10, a plurality of vehicle-end electronic devices 11, a plurality of user-end electronic devices 12, and a plurality of sensor assemblies 1S, in which the plurality of vehicle-end electronic devices 11 and the user-end electronic devices 12 are set to be in communication with the at least one server 10, and the each of plurality of vehicle-end electronic devices 11 is correspondingly disposed in each of a plurality of vehicles with contract for undertaking transportation tasks. Moreover, each of plurality of sensor assemblies 1S is correspondingly disposed in each of the plurality of vehicles, and the sensor assembly 1S is set to be in communication with the at least one server 10 directly or through the vehicle-end electronic device 11.

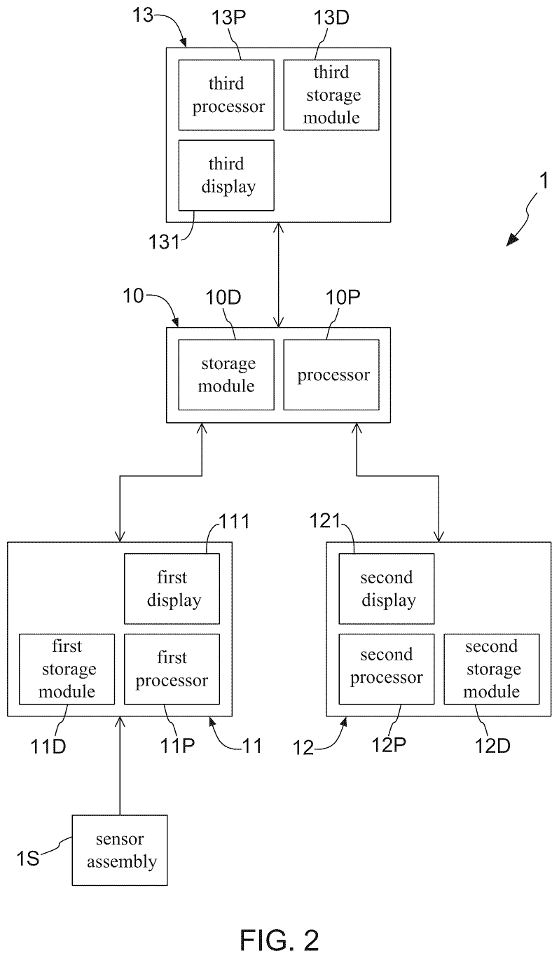

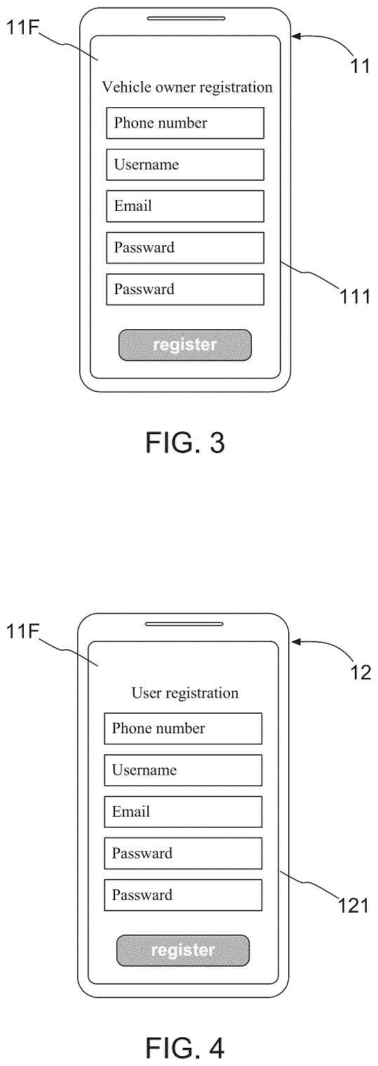

FIG. 2 depicts a block diagram of the system 1 according to the present invention. As FIG. 1 and FIG. 2 show, the vehicle-end electronic device 11 comprises a first display 111, a first processor 11P and a first storage module 11D. In contrast, the user-end electronic device 12 comprises a second display 121, a second processor 12P and a second storage module 12D. Furthermore, FIG. 3 illustrates a schematic front view of the vehicle-end electronic device 11, and FIG. 4 shows a schematic front view of the user-end electronic device 12. According to the present invention, the first storage module 11D of the vehicle-end electronic device 11 stores a first application program, and the second storage module 12D of the user-end electronic device 12 stores a second application program. By such arrangements, after a user operates his user-end electronic device 12 (e.g., smartphone) so as to make the second application program be executed, the second processor 12P of the user-end electronic device 12 control the second display 121 to show a user operation interface 12F. In such case, the user is able to edit a demand of vehicle utilization by operating the user operation interface 12F, and then send the demand of vehicle utilization to the server 10 through the user-end electronic device 12. Particularly, the demand of vehicle utilization includes an information consisting of model of vehicle, starting location and destination location. Moreover, examples for the vehicle include, but are not limited to bicycle, electric bicycle (E-bike), motorcycle, scooter, electric motorcycle, electric scooter, gasoline-powered vehicle, and electric vehicle.

As FIG. 1 and FIG. 2 show, the server 10 comprises a processor 10P and a storage module 10D, wherein the storage module 10D stores an application program, and the processor 10P executes the application program so as to be configured to:
(a) generate, after receiving a demand of vehicle utilization sent by one of the plurality of the user-end electronic devices 12, an estimation value of carbon emission and a transportation plan comprising a plurality of advisory transportation routes based on the demand of vehicle utilization, at least one vehicle parameter and at least one road condition parameter;
(b) transmit a transportation task assigning notification to one of the plurality of vehicle-end electronic devices 11 that stays in the vehicle meeting a requirement of the demand of vehicle utilization;
(c) dispatch, after receiving a response information from the vehicle-end electronic device 11, the vehicle as a transportation vehicle;
(d) collect, through the sensor assembly 1S, a driving data of the transportation vehicle while the transportation vehicle travels along the advisory transportation route;
(e) calculate, after the transportation vehicle completes the transportation task, a real value of carbon emission of the transportation vehicle; and
(f) calculate, in case of the real value of carbon emission being lower than the estimation value of carbon emission, a bonus of carbon emission reducing based on a difference between the real value of carbon emission and the estimation value of carbon emission.

It is aware that, the first application program may be executed after a driver like a vehicle owner operates the vehicle-end electronic device 11 (e.g., smartphone) that stays in the vehicle, and then the first processor 11P of the vehicle-end electronic device 11 control the first display 111 to show a driver operation interface 11F. In such case, the driver of the vehicle can decide to accept or reject a transportation task after the vehicle-end electronic device 11 receives the transportation task assigning notification. If the driver undertakes the transportation task by operating the driver operation interface 11F, an electronic map like Google map or Apple map would be shown on the first display 111 of the vehicle-end electronic device 11, and one advisory transportation route is labeled on the electronic map. As described in more detail below, the aforesaid transportation plan further comprises driving advice, and the driving advice includes, but is not limited to driving speed, engine speed and tire pressure. In other words, before driving the transportation vehicle to travel along the advisory transportation route for conducting the transportation task, the driver is able to inspect whether the tire pressure of each of the wheels of the transportation vehicle meet the suggested value or not. In addition, the vehicle speed and the engine speed can be controlled by the driver so as to meet the suggested values while the driver driving the transportation vehicle to conduct the transportation task.

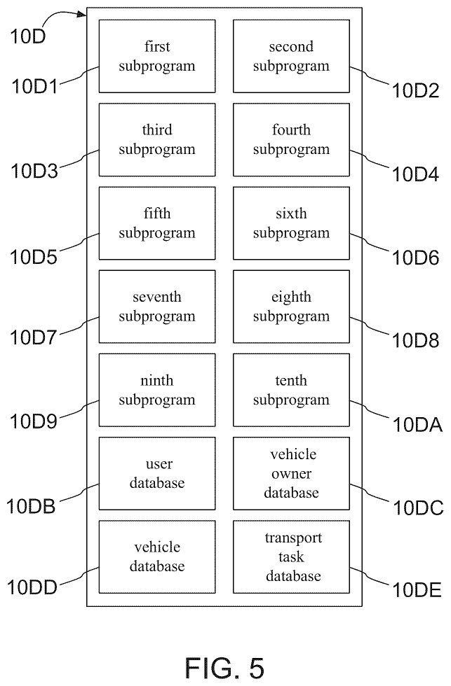

Furthermore, FIG. 5 is a block diagram of the storage module 10D as shown in FIG. 2. As FIG. 5 shows, the application program stored in the storage module 10D of the server 10 consists of a plurality of subprograms, and plurality of subprograms comprises a first subprogram 10D1, a second subprogram 10D2, a third subprogram 10D3, a fourth subprogram 10D4, a fifth subprogram 10D5, a sixth subprogram 10D6, a seventh subprogram 10D7, an eighth seventh subprogram 10D8, a ninth seventh subprogram 10D9, and a tenth seventh subprogram 10DA. Moreover, the storage module 10D further comprises a user database 10DB, a vehicle owner database 10DC, a vehicle database 10DD, and a transport task database 10DE.

After executing the second application program, the second processor 10P is configured to control the user-end electronic device 12 to communicate with the server 10, and control the second display 121 to show a user operation interface 12F. In such case the user is allowed to conduct a user operation by operating (touching) the user operation interface 12F. Examples of the user operation includes, but are not limited to user registering, user information management, user log in, editing of the demand of vehicle utilization, sending out of the demand of vehicle utilization, giving of vehicle owner score, giving of system score, order querying, order revising, order canceling, bank account setting, and enquiry for specific expense payment corresponding the transportation task.

It is worth particularly explaining that, the second subprogram 10D2 includes a function module of user operation managing. To be more specific, the second subprogram 10D2 includes instructions for configuring the processor 10P to receive the user operation through a communication interface of the server 10, subsequently manage the user operation, and eventually conduct a corresponding action with response to the user operation. For example, after a user edits and then sends out, by operating the user operation interface 12F, a user personal information comprising name, ID number and phone number to the server 10, the processor 10P executing the application program including second subprogram 10D2 is configured to receive and then store the user personal information in the user database 10DB. In addition, after the user conducts an operation of user log in by operating the user operation interface 12F, the processor 10P is enabled to conduct a verification of the username and the password inputted during the operation of user log in, and then the user successful logs into the system in case of the fact that the inputted username and password both pass the verification.

In contrast, the first subprogram 10D1 includes a function module of driver operation managing. To be more specific, the first subprogram 10D1 includes instructions for configuring the processor 10P to receive a driver operation through the communication interface, subsequently manage the driver operation, and eventually conduct a corresponding action with response to the driver operation. Examples of the driver operation include, but are not limit to vehicle owner registering (i.e., driver registering), management of vehicle owner information, vehicle information management, vehicle owner log in (i.e., driver log in), acceptation or rejection of transportation task, giving of user score, giving of system score, bank account setting, and enquiry for specific remuneration defrayment corresponding the transportation task.

For example, after a driver edits and then sends out, by operating the driver operation interface 11F, a driver personal information comprising name, ID number, driver's license number, and phone number to the server 10, the processor 10P executing the application program including first subprogram 10D1 is configured to receive and then store the driver personal information in the driver database 10DC. In addition, after the driver conducts an operation of driver log in by operating the driver operation interface 11F, the processor 10P is enabled to conduct a verification of the username and the password inputted during the operation of driver log in, and then the driver successful logs into the system in case of the fact that the inputted username and password both pass the verification. On the other hand, after the driver edits and then sends out, by operating the driver operation interface 11F, a vehicle information comprising license plate number, vehicle identification number, vehicle registration number, engine number, brand of vehicle, model of vehicle, vehicle weight, and vehicle emission standard to the server 10, the processor 10P executing the application program including first subprogram 10D1 is configured to receive and then store the vehicle information in the vehicle database 10DD.

In addition, the fourth subprogram 10D4 includes a function module of transportation plan generating. To be more specific, the fourth subprogram 10D4 includes instructions for configuring the processor 10P to:
generate an original transportation route based on the demand of vehicle utilization; and
generate, after applying N times of route adjusting process to the original transportation route under taking at least one vehicle parameter and at least one road condition parameter as a plurality of adjusting factors, the plurality of advisory transportation routes.

As explained in more detail below, N is a positive integer, and the vehicle parameters include, but are not limited to brand of vehicle, model of vehicle, vehicle weight, and vehicle emission standard. On the other hand, the road condition parameters include, but are not limited to type of road, gradient of road, speed limit of road, current traffic flow of road, environment temperature, environment humidity, and environment wind speed. It is worth mentioning that, the plurality of advisory transportation routes include, but are not limited to transportation route with shortest-distance, transportation route with lowest amount of time spending, transportation route with lowest price, and transportation route with lowest carbon emission. Moreover, the user is allowed to select one of the foregoing transportation routes.

On the other hand, the fifth subprogram 10D5 includes a function module of transportation task managing. To be more specific, the fifth subprogram 10D5 includes instructions for configuring the processor 10P to:
receive the demand of vehicle utilization through the communication interface of the server 10;
transmit, through the communication interface, the transportation task assigning notification to one of the plurality of vehicle-end electronic devices 11;
record a device information of the vehicle-end electronic device 11 while receiving a response information from the vehicle-end electronic device 11, and simultaneously record a vehicle information of the vehicle carrying the vehicle-end electronic device 11;
record the driving data and a real transportation route of the transportation vehicle and the transportation task in the transport task database 10DE; and
calculate, after the transportation vehicle completes the transportation task, the real value of carbon emission of the transportation vehicle;

The driving data includes at least one of real transportation route, trip corresponding to the foregoing real transportation route, and fuel consumption corresponding to the foregoing real transportation route. On the other hand, the driving data is collected by the sensor assembly 1S, and the sensor assembly 1S transmits the driving data to the server 10 directly or through the vehicle-end electronic device 11. As described in more detail below, examples of the sensor assembly 1S include, but are not limited to OBD (on-board diagnostics) device, ODB-II (second generation on-board diagnostics) device, OTA (over-the-air technology) device, and TMS (transportation management system) device.

As FIG. 2, FIG. 3, FIG. 4, and FIG. 5 show, the ninth subprogram 10D9 includes a function module of bonus and reward managing. To be more specific, the ninth subprogram 10D9 includes instructions for configuring the processor 10P to:
calculate, after the transportation vehicle completes the transportation task, a real value of carbon emission of the transportation vehicle; and
calculate, in case of the real value of carbon emission being lower than the estimation value of carbon emission, a bonus of carbon emission reducing based on a difference between the real value of carbon emission and the estimation value of carbon emission; and
allot, after exchanging the bonus of carbon emission reducing to a reward, the reward to a user of the user-end electronic device 12 and/or a driver (or a vehicle owner) of the vehicle-end electronic device 11.

In a practicable embodiment, the reward includes at least one of reward points, gift voucher, discount coupon, cash voucher, and currency. In addition, the server 10 is configured to further include functions of user score managing, driver score managing, order managing, expense payment managing, and remuneration defrayment managing. For example, the sixth subprogram 10D6 includes a function module of user score and driver score managing. To be more specific, the sixth subprogram 10D6 includes instructions for configuring the processor 10P to:
communicate with the vehicle-end electronic device 11 through the communication interface of the server 10, so as to receive a user score data or a first system score data; a
communicate with the user-end electronic device 12 through the communication interface so as to receive a vehicle owner score data or a second system score data.

Moreover, the seventh subprogram 10D7 includes a function module of order managing. To be more specific, the seventh subprogram 10D7 includes instructions for configuring the processor 10P to:
communicate with the user-end electronic device 12 so as to receive and manage a user operation of order querying, a user operation of order revising, or a user operation of order canceling.

Furthermore, the eighth subprogram 10D8 includes a function module of expense payment managing. To be more specific, the eighth subprogram 10D8 includes instructions for configuring the processor 10P to:
communicate with the vehicle-end electronic device 11 through the communication interface of the server 10, so as to send a remuneration defrayment notification to the vehicle-end electronic device 11 after the vehicle completes the transportation task;
receive and manage a driver operation of enquiry for specific remuneration defrayment corresponding the transportation task;
communicate with the user-end electronic device 12 through the communication interface, so as to send an expense payment notification to the user-end electronic device 12 after the transportation vehicle completes the transportation task; and
receive and manage a user operation of enquiry for specific expense payment corresponding the transportation task.

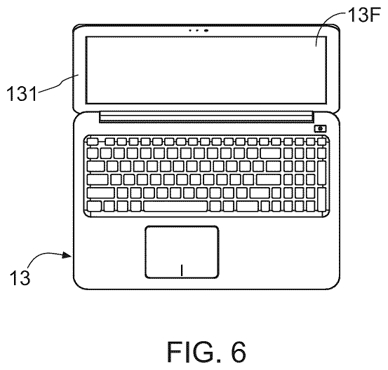

As FIG. 1, FIG. 2, and FIG. 5 show, in one practicable embodiment the system 1 according to the present invention further comprises a plurality of administrator-end electronic devices 13 in communication to the at least one server 10, and FIG. 6 is a schematic diagram of the administrator-end electronic device 13. According to the present invention, the administrator-end electronic device 13 comprises at least one third processor 13P and at least one third storage module 13D storing a third application program, and the third processor 13P executes the third application program so as to be configured to:
control the administrator-end electronic device 13 to communicate with the server 10;
control a third display 131 of the administrator-end electronic device 13 to show an administrator operation interface 13F; and
receive an administrator operation through the administrator operation interface 13F.

Correspondingly, the third subprogram 10D3 includes a function module of backstage management. To be more specific, the third subprogram 10D3 includes instructions for configuring the processor 10P to:
communicate with the administrator-end electronic device 13 so as to receive an administrator operation through the communication interface of the server 10, subsequently manage the administrator operation, and eventually conduct a corresponding action with response to the administrator operation.

Examples of the administrator operation include, but are not limit to bonus management, user data management, vehicle owner data management, vehicle data management, transportation task management, order management, user score management, and vehicle owner score management. Moreover, the storage module 10D, the first storage module 11D, the second storage module 12D, and the third storage module 13D all can be a hard drive (HD), an external hard drive, a solid-state drive (SSD), or a flash drive.

Particularly, the tenth subprogram 10DA is set to include a function module of data analysis. To be more specific, the tenth subprogram 10DA includes instructions for configuring the processor 10P to:
input the real value of carbon emission, the estimation value of carbon emission, the real transportation route, the driving data, the at least one vehicle parameter, and the at least one road condition parameter into a pre-trained factor analysis model, such that at least one factor leading the real value of carbon emission to be lower than the estimation value of carbon emission is found out by the factor analysis model.

The plurality of factors may include, for example, real traveling route of the transportation vehicle being different from the user-denoted transportation route, vehicle speed, engine speed, grade of gasoline, wind speed, gradient of road, and humidity. As a result, the system of the present invention is able to, by utilizing the factors, generate a new transportation route with more reduced carbon emission compared to the transportation route with the lowest carbon emission generated before.

In one practicable embodiment, machine learning algorithm like supervised learning algorithm or un-supervised learning algorithm can be utilized in the production of the aforesaid pre-trained factor analysis model. Specifically, the supervised learning algorithm can be decision tree algorithm or linear regression algorithm, and the un-supervised learning algorithm can be cluster analysis algorithm. Moreover, in another one practicable embodiment reinforcement learning algorithm may also be utilized in the production of the aforesaid pre-trained factor analysis model, in which the reinforcement learning algorithm is Q-learning algorithm or SARSA algorithm.

Therefore, through above descriptions, all embodiments and their constituting elements of the system for monitoring vehicle carbon footprint and generating plan of carbon emission reduction according to the present invention have been introduced completely and clearly. The system 1 according to the present invention can be integrated in a vehicle management system. When a user employs the vehicle management system by operating a user-end electronic device (e.g., smartphone) thereof, the system of the present invention is enabled to generate a plurality of advisory transportation routes based on a demand of vehicle utilization that is sent by the user-end electronic device, assign a specific transportation vehicle a transportation task, and calculate an estimation carbon emission. Particularly, the plurality of advisory transportation routes comprises transportation route with shortest-distance, transportation route with lowest amount of time spending, transportation route with lowest price, and transportation route with lowest carbon emission, and the user is allowed to select one of the foregoing transportation routes. In addition, after the transportation vehicle completes the transportation task by travelling along the user-denoted transportation route, the system of the present invention subsequently calculates a real carbon emission based on a driving data of the transportation vehicle, and then calculates a bonus based on a difference between the real carbon emission and the estimation carbon emission, thereby rewarding the bonus to the user and/or the driver of the transportation vehicle. Furthermore, an analysis is conducted by the system of the present invention after one transportation task is finished, such that a plurality of factors leading the real carbon emission to be lower than the estimation carbon emission are determined.

The plurality of factors may include, for example, real traveling route of the transportation vehicle being different from the user-denoted transportation route, vehicle speed, engine speed, grade of gasoline, wind speed, gradient of road, and humidity. As a result, the system of the present invention is able to, by utilizing the factors, generate a new transportation route with more reduced carbon emission compared to the transportation route with the lowest carbon emission generated before.

It is worth particularly emphasizing that, the above description is made on embodiments of the present invention. However, the embodiments are not intended to limit the scope of the present invention, and all equivalent implementations or alterations within the spirit of the present invention still fall within the scope of the present invention.

What is claimed is:

1. A system for monitoring vehicle carbon footprint and generating plan of carbon emission reduction, comprising:
at least one server;
a plurality of vehicle-end electronic devices in communication with the at least one server, wherein each of plurality of vehicle-end electronic devices is correspondingly disposed in each of a plurality of vehicles with contract for undertaking transportation tasks;
a plurality of user-end electronic devices in communication with the at least one server; and
a plurality of sensor assemblies, wherein each of plurality of sensor assemblies is correspondingly disposed in each of the plurality of vehicles, and the sensor assembly communicating the at least one server directly or through the vehicle-end electronic device;
wherein the server comprises at least one processor and at least one storage module storing an application program, and the processor executing the application program so as to be configured to:
generate, after receiving a demand of vehicle utilization sent by one of the plurality of the user-end electronic devices, an estimation value of carbon emission and a transportation plan comprising a plurality of advisory transportation routes based on the demand of vehicle utilization, at least one vehicle parameter and at least one road condition parameter; wherein the demand of vehicle utilization includes an information consisting of model of vehicle, starting location and destination location;
transmit a transportation task assigning notification to one of the plurality of vehicle-end electronic devices that stays in the vehicle meeting a requirement of the demand of vehicle utilization;
dispatch, after receiving a response information from the vehicle-end electronic device, the vehicle as a transportation vehicle;
collect, through the sensor assembly, a driving data of the transportation vehicle while the transportation vehicle travels along the advisory transportation route;
calculate, after the transportation vehicle completes the transportation task, a real value of carbon emission of the transportation vehicle; and
calculate, in case of the real value of carbon emission being lower than the estimation value of carbon emission, a bonus of carbon emission reducing based on a difference between the real value of carbon emission and the estimation value of carbon emission.

2. The system of claim 1, wherein the processor executing the application program is further configured to:
allot, after exchanging the bonus of carbon emission reducing to a reward, the reward to a user of the user-end electronic device and/or a driver of the vehicle-end electronic device;
wherein the reward comprises at least one selected from a group consisting of reward points, gift voucher, discount coupon, cash voucher, and currency.

3. The system of claim 1, wherein the transportation vehicle is selected from a group consisting of bicycle, electric bicycle (E-bike), motorcycle, scooter, electric motorcycle, electric scooter, gasoline-powered vehicle, and electric vehicle.

4. The system of claim 1, wherein the vehicle parameter is selected from a group consisting of brand of vehicle, model of vehicle, vehicle weight, and vehicle emission standard.

5. The system of claim 1, wherein the road condition parameter is selected from a group consisting of type of road, gradient of road, speed limit of road, current traffic flow of road, environment temperature, environment humidity, and environment wind speed.

6. The system of claim 1, wherein the transportation plan further comprises at least one driving advice selected from a group consisting of driving speed, engine speed and tire pressure.

7. The system of claim 1, wherein the driving data comprises at least one selected from a group consisting of real transportation route, trip corresponding to the foregoing real transportation route, and fuel consumption corresponding to the foregoing real transportation route.

8. The system of claim 1, wherein the sensor assembly is selected from a group consisting of OBD (on-board diagnostics) device, ODB-II (second generation on-board diagnostics) device, OTA (over-the-air technology) device, and TMS (transportation management system) device.

9. The system of claim 1, wherein the plurality of advisory transportation routes comprises transportation route with shortest-distance, transportation route with lowest amount of time spending, transportation route with lowest price, and transportation route with lowest carbon emission.

10. The system of claim 1, wherein the vehicle-end electronic device comprises a first processor and a first storage module storing a first application program, the first processor executes the first application program so as to be configured to:
control the vehicle-end electronic device to communicate with the server;
control a first display of the vehicle-end electronic device to show a driver operation interface; and
receive a driver operation through the driver operation interface;
wherein the driver operation is selected from a group consisting of vehicle owner registering, management of vehicle owner information, vehicle information management, vehicle owner log in, acceptation or rejection of transportation task, giving of user score, giving of system score, bank account setting, and enquiry for specific remuneration defrayment corresponding the transportation task.

11. The system of claim 10, wherein the user-end electronic device comprises a second processor and a second storage module storing a second application program, the second processor executes the second application program so as to be configured to:
control the user-end electronic device to communicate with the server;
control a second display of the user-end electronic device to show a user operation interface; and
receive a user operation through the user operation interface;
wherein the user operation is selected from a group consisting of user registering, user information management, user log in, editing of the demand of vehicle utilization, sending out of the demand of vehicle utilization, giving of vehicle owner score, giving of system score, order querying, order revising, order canceling, bank account setting, and enquiry for specific expense payment corresponding the transportation task.

12. The system of claim 11, further comprising:
a plurality of administrator-end electronic devices in communication to the at least one server;
wherein the administrator-end electronic device comprises at least one third processor and at least one third storage module storing a third application program, and the third processor executing the third application program so as to be configured to:
control the administrator-end electronic device to communicate with the server;
control a third display of the administrator-end electronic device to show an administrator operation interface; and
receive an administrator operation through the administrator operation interface;
wherein the administrator operation is selected from a group consisting of bonus management, user data management, vehicle owner data management, vehicle data management, transportation task management, order management, user score management, and vehicle owner score management.

13. The system of claim 12, wherein the storage module, the first storage module, the second storage module, and the third storage module are all selected from a group consisting of hard drive (HD), external hard drive, solid-state drive (SSD), and flash drive.

14. The system of claim 12, wherein the storage module includes a user database, a vehicle owner database, a vehicle database, a transport task database.

15. The system of claim 14, wherein the application program comprises a plurality of subprograms, and the plurality of subprograms comprise:
a first subprogram, including instructions for configuring the processor to receive the driver operation through a communication interface of the server, and then manage the driver operation;
a second subprogram, including instructions for configuring the processor to receive the user operation through the communication interface, and then manage the user operation;
a third subprogram, including instructions for configuring the processor to receive the administrator operation through the communication interface, and then manage the administrator operation;
a fourth subprogram, including instructions for configuring the processor to:
generate an original transportation route based on the demand of vehicle utilization; and
generate, after applying N times of route adjusting process to the original transportation route under taking the at least one vehicle parameter and the at least one road condition parameter as a plurality of adjusting factors, the plurality of advisory transportation routes; wherein N is a positive integer;
a fifth subprogram, including instructions for configuring the processor to:
receive the demand of vehicle utilization through the communication interface;
transmit, through the communication interface, the transportation task assigning notification to one of the plurality of vehicle-end electronic devices;
record a device information of the vehicle-end electronic device while receiving the response information from the vehicle-end electronic device, and simultaneously record a vehicle information of the vehicle carrying the vehicle-end electronic device;
record the driving data and a real transportation route of the transportation vehicle and the transportation task in the transport task database; and
calculate, after the transportation vehicle completes the transportation task, the real value of carbon emission of the transportation vehicle;
a sixth subprogram, including instructions for configuring the processor to:
communicate with the vehicle-end electronic device through the communication interface, so as to receive a user score data or a first system score data; and
communicate with the user-end electronic device through the communication interface so as to receive a vehicle owner score data or a second system score data;
a seventh subprogram, including instructions for configuring the processor to communicate with the user-end electronic device so as to receive and manage a user operation of order querying, a user operation of order revising, or a user operation of order canceling;
an eighth subprogram, including instructions for configuring the processor to:
communicate with the vehicle-end electronic device through the communication interface, so as to send a remuneration defrayment notification to the vehicle-end electronic device after the transportation vehicle completes the transportation task;
receive and manage a driver operation of enquiry for specific remuneration defrayment corresponding the transportation task;
communicate with the user-end electronic device through the communication interface, so as to send an expense payment notification to the user-end electronic device after the transportation vehicle completes the transportation task; and
receive and manage a user operation of enquiry for specific expense payment corresponding the transportation task; and
a ninth subprogram, including instructions for configuring the processor to:
calculate the bonus based on the difference between the real value of carbon emission and the estimation value of carbon emission;
exchange the bonus of carbon emission reducing to the reward; and
allot the reward to the user of the user-end electronic device and/or the driver of the vehicle-end electronic device.

16. The system of claim 15, wherein the plurality of subprograms further comprise:
a tenth subprogram, including instructions for configuring the processor to:
input the real value of carbon emission, the estimation value of carbon emission, the real transportation route, the driving data, the at least one vehicle parameter, and the at least one road condition parameter into a pre-trained factor analysis model, such that at least one factor leading the real value of carbon emission to be lower than the estimation value of carbon emission is found out by the factor analysis model.

17. The system of claim 16, wherein the possessor modulates a first weight corresponding to the vehicle parameter and a second weight corresponding to the road condition parameter while generating the transportation plan.

18. A vehicle management system, characterized by comprising one system for monitoring vehicle carbon footprint and generating plan of carbon emission reduction according to claim 1.
